(19) United States
(12) Patent Application Publication
(10) Pub. No.: US 2024/0384078 A1
(43) Pub. Date: Nov. 21, 2024

(54) RUBBER COMPOSITION BASED ON A COPOLYMER CONTAINING ETHYLENE UNITS AND DIENE UNITS, AND POLYETHYLENE

(71) Applicant: COMPAGNIE GENERALE DES ETABLISSEMENTS MICHELIN, Clermont-Ferrand (FR)

(72) Inventors: GUILLAUME PIBRE, Clermont-Ferrand (FR); FRANCOIS LAFORT, Clermont-Ferrand (FR); DIDIER VASSEUR, Clermont-Ferrand (FR)

(21) Appl. No.: 18/569,855

(22) PCT Filed: May 30, 2022
(86) PCT No.: PCT/FR2022/051014

§ 371 Date: Dec. 13, 2023

(30) Foreign Application Priority Data
Jun. 15, 2021 (FR) 2106304

(51) Int. Cl. C08L 23/08; B60C 1/00; C08K 5/14

(52) U.S. Cl. CPC C08L 23/0807; B60C 1/00; C08K 5/14; C08L 2207/066

(57) ABSTRACT

A rubber composition exhibits high stiffness, without using high amounts of reinforcing filler or without using reinforcing resins, while at the same time possesses improved limiting properties. This composition is based on at least one elastomer matrix containing more than 50 phr of at least one copolymer containing ethylene units and diene units, on from 0 to 50 phr of reinforcing filler, on at least 3 phr of a polyethylene and on a crosslinking system.

The present invention relates to rubber compositions intended especially for the manufacture of tyres, in particular rubber compositions constituting an internal layer of a tyre, especially the underlayer of the tread of the tyre.

Reducing greenhouse gas emissions in the field of transport is one of the major challenges facing tyre manufacturers. A great deal of progress has been made through tyres by lowering the rolling resistance, because this has a direct impact on the fuel consumption of the vehicles.

It is possible to define, within the tyre, three types of regions:
The radially exterior region in contact with the ambient air, this region essentially consisting of the tread and of the outer sidewall of the tyre. An outer sidewall is an elastomeric layer positioned outside the carcass reinforcement relative to the internal cavity of the tyre, between the crown and the bead, so as to totally or partially cover the region of the carcass reinforcement extending from the crown to the bead.
The radially interior region in contact with the inflation gas, this region generally consisting of the layer airtight to the inflation gases, sometimes known as interior airtight layer or inner liner.
The internal region of the tyre, that is to say that between the exterior and interior regions. This region includes layers or plies which are referred to here as internal layers of the tyre. These are, for example, carcass plies, tread underlayers, tyre belt plies or any other layer which is not in contact with the ambient air or the inflation gas of the tyre.

The rubber compositions making up the internal layers of the tyre, in particular the underlayer of the tread and/or the internal layers of the region of the bead, must have sufficient stiffness, whether for improving the roadholding in the case of the underlayer of the tread, or for taking up the stresses from the carcass reinforcement and transmitting the forces experienced by the tyre from the sidewall to the rim, as regards the bead.

To obtain rubber compositions having a high stiffness, it has been proposed to introduce large amounts of reinforcing fillers into these rubber compositions. However, this solution is deleterious to the hysteresis, having an adverse impact on the rolling resistance.

Another solution for increasing the stiffness of a rubber composition consists in using reinforcing resins such as phenoplast resins. However, this solution also entails an increase in hysteresis, but also generally a degradation in the limiting properties. In addition, the use of such resins may be disadvantageous from the viewpoints of hygiene and of the environment, since certain resins release formaldehyde during the manufacture of the tyre.

Reducing the hysteresis, by lowering, or even eliminating, the reinforcing filler content, of the rubber compositions, while retaining a high stiffness, and doing so without using reinforcing resins, therefore still remains a real technical difficulty for tyre manufacturers.

Continuing its research, the applicant has found, surprisingly, that the use of a specific polyolefin in a rubber composition made it possible to replace all or part of the reinforcing filler and to obtain a significant reduction in hysteresis while preserving, or even improving, the stiffness of said rubber composition, in particular at low strain, and to do so while also preserving, or even improving, the limiting properties of the rubber composition, in particular the elongation at break and the breaking stress.

Thus, one subject of the invention is a rubber composition based:
on an elastomer matrix containing more than 50 phr of at least one copolymer containing ethylene units and diene units,
on from 0 to 50 phr of reinforcing filler,
on at least 3 phr of a polyethylene and
on a crosslinking system.

Another subject of the invention is a tyre comprising a composition according to the invention.

### I-DEFINITIONS

The expression “based on” used to define the constituents of a catalytic system or of a composition is understood to mean the mixture of these constituents, or the product of the reaction of a portion or of all of these constituents with one another, at least partially, during the various phases of production of the catalytic system or of the composition. In the case of a composition, the latter may thus be in the totally or partially crosslinked state or in the non-crosslinked state.

An “elastomer matrix” is understood to mean all of the elastomers of the composition, including the copolymer defined below.

The expression “part by weight per hundred parts by weight of elastomer” (or phr) should be understood as meaning, within the meaning of the present invention, the proportion, by mass per hundred parts of elastomer present in the rubber composition under consideration.

In the present text, unless expressly indicated otherwise, all the percentages (%) indicated are mass percentages (%).

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present document, when an interval of values is denoted by the expression “from a to b”, the interval represented by the expression “between a and b” is also and preferentially denoted.

When reference is made to a “predominant” compound, this is understood to mean, for the purposes of the present invention, that this compound is predominant among the compounds of the same type in the composition, that is to say that it is the one which represents the greatest amount by mass among the compounds of the same type. Thus, for example, a predominant elastomer is the elastomer representing the greatest mass relative to the total mass of the elastomers in the composition. In the same way, a “predominant” filler is the one representing the greatest mass among the fillers of the composition. By way of example, in a system comprising only one elastomer, the latter is predominant for the purposes of the present invention, and in a system comprising two elastomers, the predominant elastomer represents more than half of the mass of the elastomers. In contrast, a “minor” compound is a compound which does not represent the greatest mass fraction among the compounds of the same type. Preferably, the term “predominant” is understood to mean present at more than 50%, preferably more than 60%, 70%, 80%, 90%, and more preferentially the “predominant” compound represents 100%.

In the present application, the expression “all of the monomer units of the copolymer” or “the total amount of the monomer units of the copolymer” means all of the constituent repeating units of the copolymer which result from the insertion of the monomers into the copolymer chain by polymerization. Unless otherwise indicated, the contents of a monomer unit or repeating unit in the copolymer of ethylene and 1,3-diene are given in molar percentage calculated on the basis of all of the monomer units of the copolymer.

The compounds mentioned in the description can be of fossil origin or can be biobased. In the latter case, they may be partially or totally derived from biomass or may be obtained from renewable starting materials derived from biomass. Similarly, the compounds mentioned may also originate from the recycling of already-used materials, i.e. they may partially or totally result from a recycling process, or else be obtained from starting materials which themselves result from a recycling process. Polymers, plasticizers, fillers, and the like, are concerned in particular.

Unless indicated otherwise, all the glass transition temperature “Tg” values described herein are measured in a known manner by DSC (Differential Scanning Calorimetry) according to the standard ASTM D3418 (1999).

### II-DESCRIPTION OF THE INVENTION

### II-1 Elastomer matrix

According to the invention, the elastomer matrix comprises more than 50 phr of at least one copolymer containing ethylene units and diene units (hereinafter referred to as “the copolymer”).

The term “elastomer matrix” is understood to mean all of the elastomers of the composition.

The term “copolymer containing ethylene units and diene units” is understood to mean any copolymer comprising, within its structure, at least ethylene units and diene units. The copolymer can thus comprise monomer units other than ethylene units and diene units. For example, the copolymer may also comprise a-olefin units, in particular α-olefin units having from 3 to 18 carbon atoms, advantageously having 3 to 6 carbon atoms. For example, the α-olefin units can be selected from the group consisting of propylene, butene, pentene, hexene or mixtures thereof.

In a known manner, the expression “ethylene unit” refers to the —(CH₂-CH₂)- subunit resulting from the insertion of ethylene into the elastomer chain.

20 The term “diene unit” is understood to mean a monomer unit originating from the insertion of a monomer subunit resulting from the polymerization of a conjugated diene monomer or of a non-conjugated diene monomer, the diene unit comprising a carbon—carbon double bond. Preferably, the diene units are selected from the group consisting of butadiene units, isoprene units and mixtures of these diene units. In particular, the diene units of the copolymer can be 1,3-diene units having 4 to 12 carbon atoms, for example 1,3-butadiene or 2-methyl-1,3-butadiene units. More preferably, the diene units are predominantly, or even preferentially exclusively, 1,3-butadiene units.

In the copolymer, the ethylene units advantageously represent between 50 mol % and 95 mol % of the monomer units of the copolymer, that is to say between 50 mol % and 95 mol % of the monomer units of the copolymer. Advantageously, the ethylene units in the copolymer represent between 55 mol % and 90 mol %, preferably from 60 mol % to 90 mol %, preferably from 70 mol % to 85 mol %, of the monomer units of the copolymer.

Advantageously, the copolymer (that is to say, as a reminder, the at least one copolymer containing ethylene units and diene units) is a copolymer of ethylene and of 1,3-diene (preferably 1,3-butadiene), that is to say, according to the invention, a copolymer consisting exclusively of ethylene units and of 1,3-diene (preferably 1,3-butadiene) units.

When the copolymer is a copolymer of ethylene and of a 1,3-diene, said copolymer advantageously contains units of formula (I) and/or (II). The presence of a saturated 6-membered cyclic unit, 1,2-cyclohexanediyl, of formula (I) as a monomer unit in the copolymer can result from a series of very particular insertions of ethylene and of 1,3-butadiene in the polymer chain during its growth.

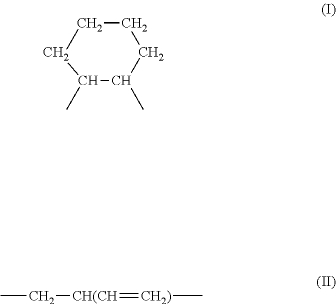

For example, the copolymer of ethylene and of a 1,3-diene can be devoid of units of formula (I). In this case, it preferably contains units of formula (II).

When the copolymer of ethylene and of a 1,3-diene comprises units of formula (I) or units of formula (II) or else units of formula (I) and units of formula (II), the molar percentages of the units of formula (I) and of the units of formula (II) in the copolymer, respectively o and p, preferably satisfy the following equation (eq. 1), more preferentially satisfy the equation (eq. 2), o and p being calculated on the basis of all of the monomer units of the copolymer.

$$0 < o + p \leq 25 \qquad ( eq . 1 )$$

$$0 < o + p < 20 \qquad ( eq . 2 )$$

According to the invention, the copolymer, preferably the copolymer of ethylene and of a 1,3-diene (preferably of 1,3-butadiene), is a random copolymer.

Advantageously, the number-average mass (Mn) of the copolymer, preferably of the copolymer of ethylene and of a 1,3-diene (preferably of 1,3-butadiene), is within a range extending from 100 000 to 300 000 g/mol, preferably from 150 000 to 250 000 g/mol.

The Mn of the copolymer is determined in a known manner by size exclusion chromatography (SEC) as described in point IV-1.2 below.

The copolymer can be obtained according to various synthesis methods known to those skilled in the art, notably as a function of the targeted microstructure of the copolymer. Generally, it can be prepared by copolymerization at least of a diene, preferably a 1,3-diene, more preferably 1,3-butadiene, and of ethylene and according to known synthesis methods, in particular in the presence of a catalytic system comprising a metallocene complex. Mention may be made in this respect of catalytic systems based on metallocene complexes, which catalytic systems are described in the documents EP 1 092 731, WO 2004035639, WO 2007054223 and WO 2007054224 in the name of the applicant. The copolymer, including the case when it is random, may also be prepared via a process using a catalytic system of preformed type such as those described in the documents WO 2017093654 A1, WO 2018020122 A1 and WO 2018020123 A1.

The copolymer may consist of a mixture of copolymers containing ethylene units and diene units which differ from each other by virtue of their microstructures and/or their macrostructures.

According to the invention, the elastomer matrix can comprise at least one other elastomer which is not a copolymer containing ethylene units and diene units, but this is neither necessary nor preferred. Thus, preferentially, the content of the at least one copolymer containing ethylene units and diene units is within a range extending from 50 to 100 phr, preferably from 60 to 100 phr, more preferably from 80 to 100 phr. Advantageously, the at least one copolymer containing ethylene units and diene units is the only elastomer of the composition, that is to say that it represents 100% by mass of the elastomer matrix.

When the elastomer matrix comprises at least one other elastomer which is not a copolymer containing ethylene units and diene units, the at least one other elastomer can be a diene elastomer, for example selected from the group consisting of polybutadienes (BRs), natural rubber (NR), synthetic polyisoprenes (IRs), butadiene copolymers, isoprene copolymers, and mixtures of these elastomers. The butadiene copolymers are particularly selected from the group consisting of butadiene/styrene copolymers (SBRs).

### II-2 Polyethylene

The rubber composition according to the invention also has the essential feature of comprising at least 3 phr of a polyethylene.

Surprisingly, the applicant has found that it was possible to replace all or part of the reinforcing fillers conventionally used in rubber compositions intended in particular for the manufacture of tyres with a polyethylene and to obtain rubber compositions which exhibit significantly improved mechanical properties.

Polyethylene (also called “PE”) is a semicrystalline polyolefin belonging to the family of thermoplastic polymers.

In the context of the present invention, the term “polyethylene” denotes ethylene homopolymers, that is to say polymers obtained from ethylene as the only monomer. However, the presence in this polymer of propylene, 1-butene, 1-hexene or 1-octene monomers is not ruled out. However, if these monomers are present, they are present as impurity and in small proportions, preferably of less than 5% by weight relative to the total weight of the polyethylene and the impurities. Copolymers of ethylene and propylene (also called EP, EPM or EPR for “ethylene propylene rubber”) do not fall within the scope of the definition of polyethylene mentioned above.

Preferably, the polyethylene which can be used in the context of the present invention is a non-crosslinked polyethylene. For the purposes of the present invention, the term “non-crosslinked polyethylene” is understood to mean a polyethylene which has not undergone a crosslinking reaction. It is therefore not a crosslinked polyethylene, also called PEX (for “PE crosslinked”). The crosslinked polyethylenes PEX are obtained by polymerization of ethylene monomer followed by a crosslinking reaction which may be a crosslinking using a peroxide (PEX-A process), a crosslinking by irradiation (PEX-C process), a crosslinking by silane and a crosslinking catalyst (PEX-B process). Of course, the non-crosslinked polyethylene may undergo a crosslinking step after its incorporation into a rubber composition in accordance with the invention, for example during the curing of a tyre comprising a rubber composition in accordance with the invention.

Preferentially, the polyethylene is selected from the group consisting of high density polyethylenes (HDPEs), low density polyethylenes (LDPEs), linear low density polyethylenes (LLDPEs), medium density polyethylenes (MDPEs), ultra high molecular weight polyethylenes (UHMWPEs), very low density polyethylenes (VLDPEs), and mixtures of these polyethylenes. High density polyethylenes are particularly preferred.

Preferentially, the polyethylene, especially high density polyethylene, has a density within a range extending from 940 to 970 kg/m³, more preferentially within a range extending from 940 to 965 kg/m³, more preferentially still within a range extending from 950 to 970 kg/m³. The density is measured at 23° C. in accordance with the standard ISO 1183-2019.

Preferentially, the polyethylene, especially high density polyethylene, has a melt flow rate at 190°° C. under 5 kg within a range extending from 2 to 25 g/10 min, preferably within a range extending from 2.5 to 22 g/10 min, more preferentially still within a range extending from 10 to 25 g/10 min. The melt flow rate (MFR 190° C./5 kg) (“MFR” for “Mass Flow Rate” is measured according to the standard ISO 1133-1-2012 at 190°° C. through a standardized die under the action of a piston weighted with a mass of 5 kg).

The polyethylene which can be used in the context of the invention can be a functionalized or non-functionalized polyethylene.

The term “non-functionalized polyethylene” is understood to mean a polyethylene which has not been modified after its polymerization by grafting a functional group comprising at least one heteroatom selected from Si, N, S, O and Cl. In other words, the non-functionalized polyethylene consists essentially of a mixture of carbon and hydrogen atoms and does not comprise heteroatoms selected from the group consisting of Si, N, S, O and Cl. If these heteroatoms are present in the polyethylene, they are present as impurity.

More preferentially still, the polyethylene is a non-functionalized and preferably non-crosslinked polyethylene, especially a non-functionalized and preferably non-crosslinked high density polyethylene, and has a density measured at 23° C. in accordance with the standard ISO 1183-2019 within a range extending from 940 to 970 kg/m³ and a melt flow rate (190° C./5 kg) measured in accordance with the standard ISO 1133-1-2012 within a range extending from 2 to 25 g/10 min. Yet more preferably still, the non-functionalized and preferably non-crosslinked polyethylene, especially non-functionalized and preferably non-crosslinked high density polyethylene, has a density measured at 23° C. in accordance with the standard ISO 1183-2019 within a range extending from 950 to 970 kg/m³ and a melt flow rate (190° C./5 kg) within a range extending from 10 to 25 g/10 min.

The non-functionalized polyethylene which can be used can be obtained by known conventional processes such as, in particular, polymerization in the presence of metallocene catalysts. At the end of the polymerization, the polyethylene is pelletized without any crosslinking reaction. Non-functionalized polyethylenes are commercially available from suppliers such as Dow Global Technologies, BASF, Silon, ENI, etc.

The polyethylene which can be used in the context of the invention can also be a functionalized polyethylene. For the purposes of the present invention, the term “functionalized polyethylene” is understood to mean a polyethylene which has undergone a modification reaction, after its polymerization, so as to include at least one functional group comprising at least one heteroatom selected from the group consisting of Si, N, O, S and Cl. Particularly suitable functional groups are those comprising at least one function such as: silanol, an alkoxysilane, a chlorine atom. The modification or functionalization of a polyethylene can be effected by any known means, in particular by grafting a functional group comprising at least one heteroatom. At the end of this reaction, the functionalized polyethylene does not undergo a crosslinking reaction. Functionalized polyethylenes may be commercially available from suppliers such as Dow Global Technologies, BASF, Silon, ENI, etc.

Preferentially, the functionalized and preferably non-crosslinked polyethylene comprises at least one alkoxysilane functional group. In the remainder of the description, this polyethylene will be denoted by the expression “alkoxysilane-functionalized polyethylene” or by the expression “silane-grafted polyethylene” or by “alkoxysilane polyethylene”; these three expressions being equivalent and interchangeable.

The alkoxysilane-functionalized polyethylene is obtained by grafting onto the polyethylene a silane compound of formula (I)

CH₂═CR—(COO)ₓ(CₙH₂ₙ)ySiR′₃ (I)
in which:
R is a hydrogen atom or a methyl group;
x, y is an integer equal to 0 or 1 with the condition that when x=1 then y=1;
n is an integer ranging from 1 to 12; preferably from 1 to 4;
each R′, which may be identical or different, is a chemical group selected from the group consisting of alkoxy groups having from 1 to 12 carbon atoms (for example methoxy, ethoxy, butoxy), aryloxy groups having from 6 to 12 carbon atoms (for example phenoxy), aliphatic acyloxy groups having from 1 to 12 carbon atoms (for example formyloxy, acetyloxy, propanoyloxy), substituted or unsubstituted amino groups (for example alkylamino).

In particular, the preferred compounds of formula (I) may be those for which:
R is a hydrogen atom or a methyl group;
x, y is an integer equal to 0 or 1 with the condition that when x=1 then y=1;
n is an integer ranging from 1 to 12; preferably from 1 to 4;
each R′, which may be identical or different, is an alkoxy group having from 1 to 12 carbon atoms, preferably methoxy, ethoxy, butoxy.

The compound of formula (I) can be grafted onto the polyethylene by a radical reaction in the presence of peroxides. The grafting reaction can be carried out in an extruder. At the outlet from the extruder, a silane-grafted and non-crosslinked polyethylene is

obtained. An example of a grafting process is described in paragraphs [0042] to [0048] of the document EP2407496A1. Silane-grafted polyethylenes are commercially available from suppliers such as Dow Global Technologies, BASF, Silon, ENI, etc.

Preferentially, the functionalized and preferably non-crosslinked polyethylene, especially the alkoxysilane-functionalized polyethylene, may be selected from the group consisting of high density polyethylenes, low density polyethylenes, linear low density polyethylenes, medium density polyethylenes, ultra high molecular weight polyethylenes, very low density polyethylenes, and mixtures of these polyethylenes. More preferentially still, the functionalized and non-crosslinked polyethylene, in particular alkoxysilane-functionalized and non-crosslinked polyethylene, is a high density polyethylene.

Preferentially, the functionalized and preferably non-crosslinked polyethylene, especially alkoxysilane-functionalized polyethylene, has a density within a range extending from 940 to 970 kg/m³, more preferentially within a range extending from 940 to 965 kg/m³. The density is measured at 23° C. in accordance with the standard ISO 1183-2019.

Preferentially, the functionalized and preferably non-crosslinked polyethylene, especially the alkoxysilane-functionalized and non-crosslinked polyethylene, has a melt flow rate at 190° C. under 5 kg within a range extending from 2 to 25 g/10 min, preferably within a range extending from 2.5 to 22 g/10 min. The melt flow rate (MFR 190° C./5 kg) (“MFR” for “Mass Flow Rate” is measured according to the standard ISO 1133-1-2012 at 190° C. through a standardized die under the action of a piston weighted with a mass of 5 kg).

More preferentially still, the functionalized and preferably non-crosslinked polyethylene, especially the alkoxysilane-functionalized polyethylene, has a density measured at 23°° C. in accordance with the standard ISO 1183-2019 within a range extending from 940 to 970 kg/m³ and a melt flow rate (MFR 190° C./5 kg) measured in accordance with the standard ISO 1133-1-2012 within a range extending from 2 to 25 g/10 min. Yet more preferably still, its density measured at 23° C. in accordance with the standard ISO 1183-2019 is within a range extending from 940 to 960 kg/m³ and it has a melt flow rate (190° C./5 kg) within a range extending from 2 to 10 g/10 min.

Preferentially, the content of polyethylene in the rubber composition, whether it be functionalized, especially alkoxysilane-functionalized, or non-functionalized, is within a range extending from 3 phr to 75 phr, preferably from 4 to 60 phr, more preferably from 5 to 50 phr.

### II-3 Reinforcing Filler

The rubber composition in accordance with the invention has the further essential feature of comprising from 0 to 50 phr of reinforcing filler. In other words, the composition may not comprise reinforcing filler, or, if it does comprise reinforcing filler, does so in a content which is less than 50 phr.

Advantageously, the content of reinforcing filler in the composition according to the invention is within a range extending from 0 to 40 phr, preferably from 0 to 35 phr, preferably from 0 to 20 phr. For example, the content of reinforcing filler in the composition according to the invention can be within a range extending from 2 to 40 phr, for example from 5 to 35 phr, for example from 5 to 20 phr.

The reinforcing filler can be any type of “reinforcing” filler known for its abilities to reinforce a rubber composition which can be used in particular for the manufacture of tyres, for example an organic filler, such as carbon black, an inorganic filler, such as silica, or also a mixture of these two types of fillers. Such a reinforcing filler typically consists of nanoparticles, the (mass-) average size of which is less than a micrometre, generally less than 500 nm, usually between 20 and 200 nm, in particular and more preferentially between 20 and 150 nm. Advantageously, the reinforcing filler is selected from carbon blacks, silicas, and mixtures thereof.

Suitable carbon blacks include all carbon blacks, notably the blacks conventionally used in tyres or their treads. Among the latter, mention will be made more particularly of the reinforcing carbon blacks of the 100, 200 and 300 series, or the blacks of the 500, 600 or 700 series (ASTM D-1765-2017 grades), for instance the N115, N134, N234, N326, N330, N339, N347, N375, N550, N683 and N772 blacks. These carbon blacks can be used in the isolated state, as commercially available, or in any other form, for example as support for some of the rubber additives used. The carbon blacks might, for example, be already incorporated into the diene elastomer, notably an isoprene elastomer, in the form of a masterbatch (see, for example, patent applications WO 97/36724-A2 and WO 99/16600-A1).

Advantageously, if a reinforcing filler is present in the composition, it predominantly, preferably exclusively, comprises carbon black.

When a reinforcing inorganic filler is used, it may in particular be mineral fillers of the siliceous type, preferentially silica (SiO₂), or of the aluminous type, especially alumina (Al₂O₃). The silica used can be any reinforcing silica known to those skilled in the art, in particular any precipitated or fumed silica having a BET specific surface area and also a CTAB specific surface area both of less than 450 m²/g, preferably within a range extending from 30 to 400 m²/g, in particular from 60 to 300 m²/g.

The term “reinforcing inorganic filler” should be understood here as meaning any inorganic or mineral filler, whatever its colour and its origin (natural or synthetic), also known as “white filler”, “clear filler” or even “non-black filler”, in contrast to carbon black, capable of reinforcing, by itself alone, without means other than an intermediate coupling agent, a rubber composition intended for the manufacture of tyres. In a known way, some reinforcing inorganic fillers can be characterized in particular by the presence of hydroxyl (—OH) groups at their surface.

Any type of precipitated silica, in particular highly dispersible precipitated silicas (referred to as “HDS” for “highly dispersible” or “highly dispersible silica”), can be used. These precipitated silicas, which are or are not highly dispersible, are well known to those skilled in the art. Mention may be made, for example, of the silicas described in patent applications WO03/016215-A1 and WO03/016387-A1. Use may in particular be made, among commercial HDS silicas, of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silica, of the following commercial silicas: the Ultrasil® VN2GR and Ultrasil® VN3GR silicas from Evonik, the Zeosil® 175GR silica from Solvay or the Hi-Sil EZ120G (-D), Hi-Sil EZ160G (-D), Hi-Sil EZ200G (-D), Hi-Sil 243LD, Hi-Sil 210 and Hi-Sil HDP 320G silicas from PPG.

The reinforcing inorganic filler can be a mixture of various reinforcing inorganic fillers, in which case the proportions of reinforcing inorganic filler in the reinforcing filler relate to all of the reinforcing inorganic fillers.

In order to couple the reinforcing inorganic filler to the diene elastomer, use may be made, in a well-known way, of an at least bifunctional coupling agent (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the diene elastomer. For example, such a bifunctional compound can comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the organosilanes are selected from the group consisting of organosilane polysulfides (symmetrical or asymmetrical), such as bis(3-triethoxysilylpropyl) tetrasulfide, abbreviated to TESPT, sold under the name Si69 by Evonik, or bis(triethoxysilylpropyl) disulfide, abbreviated to TESPD, sold under the name Si75 by Evonik, polyorganosiloxanes, mercaptosilanes, blocked mercaptosilanes, such as S-(3-(triethoxysilyl) propyl) octanethioate sold by Momentive under the name NXT Silane. More preferentially, the organosilane is an organosilane polysulfide.

Of course, use might also be made of mixtures of the coupling agents described above.

When a reinforcing inorganic filler is used, the content of coupling agent in the composition of the invention can easily be adjusted by those skilled in the art. Typically, the content of coupling agent represents from 0.5% to 15% by weight, relative to the amount of reinforcing inorganic filler.

### II-4 Crosslinking System

The crosslinking system can be any type of system known to those skilled in the art in the field of rubber compositions for tyres. It may in particular be based on sulfur and/or on peroxide and/or on bismaleimides.

Preferentially, the crosslinking system comprises, preferably consists in, a peroxide, preferably an organic peroxide.

The term “organic peroxide” is understood to mean an organic compound, that is to say a compound containing carbon, comprising an —O—O- group (two oxygen atoms connected by a single covalent bond). During the crosslinking process, the organic peroxide decomposes at its unstable O—O bond to give free radicals. These free radicals make possible the creation of the crosslinking bonds.

The organic peroxide is preferably selected from the group comprising or consisting of dialkyl peroxides, monoperoxycarbonates, diacyl peroxides, peroxyketals and peroxyesters.

Preferably, the dialkyl peroxides are selected from the group comprising or consisting of dicumyl peroxide, di(t-butyl) peroxide, t-butyl cumyl peroxide, 2,5-dimethyl-2,5-di(t-butylperoxy) hexane, 2,5-dimethyl-2,5-di(t-amylperoxy) hexane, 2,5-dimethyl-2,5-di(t-butylperoxy) hex-3-yne, 2,5-dimethyl-2,5-di(t-amylperoxy) hex-3-yne, α,α′-di [(t-butylperoxy) isopropyl] benzene, α,α′-di [(t-amylperoxy) isopropyl] benzene, di(t-amyl) peroxide, 1,3,5-tri [(t-butylperoxy) isopropyl] benzene, 1,3-dimethyl-3-(t-butylperoxy) butanol and 1,3-dimethyl-3-(t-amylperoxy) butanol.

Certain monoperoxycarbonates, such as OO-tert-butyl O-(2-ethylhexyl) monoperoxycarbonate, OO-tert-butyl O-isopropyl monoperoxycarbonate and OO-tert-amyl O-(2-ethylhexyl) monoperoxycarbonate, can also be used.

Among the diacyl peroxides, the preferred peroxide is benzoyl peroxide.

Among the peroxyketals, the preferred peroxides are selected from the group comprising or consisting of 1,1-di(t-butylperoxy)-3,3,5-trimethylcyclohexane, n-butyl 4,4-di(t-butylperoxy) valerate, ethyl 3,3-di(t-butylperoxy) butyrate, 2,2-di(t-amylperoxy) propane, 3,6,9-triethyl-3,6,9-trimethyl-1,4,7-triperoxynonane (or methyl ethyl ketone peroxide cyclic trimer), 3,3,5,7,7-pentamethyl-1,2,4-trioxepane, n-butyl 4,4-bis(t-amylperoxy) valerate, ethyl 3,3-di(t-amylperoxy) butyrate, 1,1-di(t-butylperoxy) cyclohexane, 1,1-di(t-amylperoxy) cyclohexane, and mixtures thereof. Preferably, the peroxyesters are selected from the group consisting of tert-butyl peroxybenzoate, tert-butyl peroxy-2-ethylhexanoate and tert-butyl peroxy-3,5,5-trimethylhexanoate.

To summarize, the organic peroxide is, particularly preferably, selected from the group consisting of dicumyl peroxide, aryl or diaryl peroxides, diacetyl peroxide, benzoyl peroxide, dibenzoyl peroxide, di(tert-butyl) peroxide, tert-butyl cumyl peroxide, 2,5-bis(tert-butylperoxy)-2,5-dimethylhexane, n-butyl 4,4-di(tert-butylperoxy) valerate, OO-(t-butyl) O-(2-ethylhexyl) monoperoxycarbonate, tert-butyl peroxyisopropyl carbonate, tert-butyl peroxybenzoate, tert-butyl peroxy-3,5,5-trimethylhexanoate, 1,3 (4)-bis(tert-butylperoxyisopropyl)benzene, and mixtures thereof. More preferably, the organic peroxide is selected from the group consisting of from the group consisting of dicumyl peroxide, n-butyl 4,4-di(tert-butylperoxy) valerate, OO-(t-butyl) O-(2-ethylhexyl) monoperoxycarbonate, tert-butyl peroxyisopropyl carbonate, tert-butyl peroxybenzoate, tert-butyl peroxy-3,5,5-trimethylhexanoate, 1,3(4)-bis(tert-butylperoxyisopropyl)benzene, and mixtures thereof.

The content of peroxide, preferably of organic peroxide, in the composition is advantageously within a range extending from 0.1 to 10 phr, preferably from 0.5 to 5 phr, more preferably from 1 to 4 phr.

Mention may be made, as examples of commercially available peroxides which can be used in the context of the present invention, of Dicup from Hercules Powder Co., Perkadox Y12 from Noury van der Lande, Peroximon F40 from Montecatini Edison S.p.A., Trigonox from Noury van der Lande, Varox from R.T. Vanderbilt Co. or else Luperko from Wallace & Tiernan Inc.

Furthermore, the composition according to the invention is advantageously free of sulfur as vulcanization agent, or contains less than 0.9 phr, preferably less than 0.5 phr, preferably less than 0.3 phr, preferably less than 0.2 phr and preferably less than 0.1 phr, thereof. The sulfur can be molecular sulfur or can originate from a sulfur-donating agent, such as alkylphenol disulfides (APDSs).

### II-5 Possible additives

The rubber compositions according to the invention may optionally also include all or some of the usual additives customarily used in elastomer compositions for tyres, for instance plasticizers (such as plasticizing oils and/or plasticizing resins), pigments, protective agents such as anti-ozone waxes, chemical anti-ozonants, antioxidants, anti-fatigue agents, reinforcing resins (as described, for example, in patent application WO 02/10269).

The composition does not require the use of reinforcing resins (or hardening resins) known those skilled in the art for stiffening rubber compositions, in particular by increasing their Young's modulus or also the complex dynamic shear G*. Particularly advantageously, the composition according to the invention does not comprise reinforcing resin or comprises less than 1 phr, preferably less than 0.5 phr, thereof. Examples of such reinforcing resins can be found in chapter II.3 of patent application WO20198679A1.

### II-6 Preparation of the Rubber Compositions

The compositions in accordance with the invention can be manufactured in appropriate mixers using two successive preparation phases that are well known to those skilled in the art:
a first phase of thermomechanical working or kneading (“non-productive” phase), that can be performed in a single thermomechanical step during which all the necessary constituents, notably the elastomeric matrix, the reinforcing filler and the various other optional additives, with the exception of the crosslinking system, are introduced into an appropriate mixer, such as a standard internal mixer (for example of Banbury type). The incorporation of the optional filler into the elastomer may be performed in one or more portions while thermomechanically kneading. In the case where the filler is already incorporated, totally or partly, into the elastomer in the form of a masterbatch, as is described, for example, in patent applications WO 97/36724 or WO 99/16600, it is the masterbatch which is directly kneaded and, where appropriate, the other elastomers or fillers present in the composition which are not in masterbatch form, and also the various other optional additives, with the exception of the crosslinking system, are incorporated. The non-productive phase may be performed at high temperature, up to a maximum temperature of between 110° C. and 200° C., preferably between 130° C. and 185° C., for a period of time generally of between 2 and 10 minutes;
a second phase of mechanical working (“productive” phase), which is performed in an external mixer, such as an open mill, after cooling the mixture obtained during the first non-productive phase down to a lower temperature, typically below 120° C., for example between 40° C. and 100° C. The crosslinking system is then incorporated and the combined mixture is then mixed for a few minutes, for example between 5 and 15 min.

Such phases have been described, for example, in patent applications EP-A-0501227, EP-A-0735088, EP-A-0810258, WO 00/05300 or WO 00/05301.

The final composition thus obtained is then calendered, for example in the form of a sheet or of a slab, notably for laboratory characterization, or else is extruded (or co-extruded with another rubber composition) in the form of a rubber semi-finished product (or profiled element) which can be used, for example, as a tyre sidewall. These products may then be used for the manufacture of tyres, according to the techniques known to those skilled in the art.

The composition may be either in the raw state (before crosslinking or vulcanization) or in the cured state (after crosslinking or vulcanization), and may be a semi-finished product which can be used in a tyre.

The crosslinking (or curing), or, where appropriate, the vulcanization, is performed in a known manner at a temperature generally between 130° C. and 200° C., for a sufficient time which may range, for example, between 5 and 90 min, notably depending on the curing temperature, the crosslinking system adopted and the crosslinking kinetics of the composition under consideration.

### II-7 Tyre

A subject of the present invention is also a tyre comprising a rubber composition according to the invention.

The composition defined in the present description is particularly well suited to the internal layers of tyres. Thus, preferably, the composition according to the invention is present at least in at least one internal layer of the tyre.

Advantageously, the internal layer of the tyre is selected from the group consisting of carcass plies, crown plies, bead-wire fillings, crown feet, decoupling layers, edge rubbers, filler rubbers, tread underlayer and combinations of these internal layers, preferably tread underlayer. In the present text, the term “edge rubber” is understood to mean a layer positioned in the tyre directly in contact with the end of a reinforcing ply, with the end of a reinforcing element or with another edge rubber.

The tyre according to the invention may be intended to equip motor vehicles of passenger vehicle type, SUVs (sport utility vehicles), or two-wheel vehicles (notably motorcycles), or aircraft, or else industrial vehicles chosen from vans, heavy-duty vehicles, i.e. underground trains, buses, heavy road transport vehicles (lorries, tractors, trailers) or off-road vehicles, such as heavy agricultural vehicles or civil engineering equipment, and the like.

### III-Preferred Embodiments

In the light of the above, the preferred embodiments of the invention are described below:
1. Rubber composition based on an elastomer matrix containing more than 50 phr of at least one copolymer containing ethylene units and diene units, on from 0 to 50 phr of reinforcing filler, on at least 3 phr of a polyethylene and on a crosslinking system.
2. Rubber composition according to Embodiment 1, in which the copolymer containing ethylene units and diene units is a copolymer of ethylene and of 1,3-diene.
3. Rubber composition according to Embodiment 2, in which the 1,3-diene is 1,3-butadiene.
4. Rubber composition according to either one of Embodiments 2 and 3, in which the copolymer contains units of formula (I) or units of formula (II) or else units of formula (I) and of formula (II):

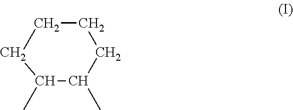

—CH₂-CH(CH═CH₂)- (II)
5. Rubber composition according to Embodiment 4, in which the molar percentages of the units of formula (I) and of the units of formula (II) in the copolymer, respectively o and p, satisfy the following equation (eq. 1), preferentially satisfy the equation (eq. 2), o and p being calculated on the basis of all of the monomer units of the copolymer:

$$0 < o + p \leq 25 \qquad ( eq . 1 )$$

$$0 < o + p < 20 \qquad ( eq . 2 )$$

6. Rubber composition according to any one of the preceding embodiments, in which the ethylene units in the copolymer represent between 50 mol % and 95 mol %, preferably between 55 mol % and 90 mol %, of the monomer units of the copolymer.
7. Rubber composition according to any one of the preceding embodiments, in which the copolymer is a random copolymer.
8. Rubber composition according to any one of the preceding embodiments, in which the copolymer has a number-average mass, Mn, that is within a range extending from 100 000 to 300 000 g/mol, preferably from 150 000 to 250 000 g/mol.
9. Rubber composition according to any one of the preceding embodiments, in which the content of the copolymer containing ethylene units and diene units is within a range extending from 60 to 100 phr, preferably from 80 to 100 phr.
10. Rubber composition according to any one of the preceding embodiments, in which the polyethylene is a non-crosslinked polyethylene.
11. Rubber composition according to any one of the preceding embodiments, in which the polyethylene is selected from the group consisting of high density polyethylenes, low density polyethylenes, linear low density polyethylenes, medium density polyethylenes, ultra high molecular weight polyethylenes, very low density polyethylenes, and mixtures of these polyethylenes.
12. Rubber composition according to any one of the preceding embodiments, in which the polyethylene is a non-crosslinked high density polyethylene HDPE.
13. Rubber composition according to any one of the preceding embodiments, in which the polyethylene has a density within a range extending from 940 to 970 kg/m³, more preferentially within a range extending from 940 to 965 kg/m³.
14. Rubber composition according to any one of the preceding embodiments, in which the polyethylene has a melt flow rate at 190° C. under 5 kg within a range extending from 2 to 25 g/10 min, preferably within a range extending from 2.5 to 22 g/10 min.
15. Rubber composition according to any one of the preceding embodiments, in which the polyethylene is functionalized.
16. Rubber composition according to Embodiment 15, in which the functionalized polyethylene comprises at least one alkoxysilane functional group.
17. Rubber composition according to any one of the preceding embodiments, in which the content of polyethylene is within a range extending from 3 to 75 phr, preferably from 4 to 60 phr.
18. Rubber composition according to any one of the preceding embodiments, in which the content of reinforcing filler is within a range extending from 0 to 40 phr, preferably from 0 to 35 phr.
19. Rubber composition according to any one of the preceding embodiments, in which the reinforcing filler is selected from carbon blacks, silicas, and mixtures thereof.
20. Rubber composition according to any one of the preceding embodiments, in which the reinforcing filler predominantly, preferably exclusively, comprises carbon black.
21. Rubber composition according to any one of the preceding embodiments, in which the crosslinking system is based on sulfur and/or on peroxide and/or on bismaleimides.
22. Rubber composition according to any one of the preceding embodiments, in which the crosslinking system comprises at least one organic peroxide, preferably selected from the group consisting of dicumyl peroxide, aryl or diaryl peroxides, diacetyl peroxide, benzoyl peroxide, dibenzoyl peroxide, di(tert-butyl) peroxide, tert-butyl cumyl peroxide, 2,5-bis(tert-butylperoxy)-2,5-dimethylhexane, n-butyl 4,4-di(tert-butylperoxy) valerate, OO-(t-butyl) O-(2-ethylhexyl) monoperoxycarbonate, tert-butyl peroxyisopropyl carbonate, tert-butyl peroxybenzoate, tert-butyl peroxy-3,5,5-trimethylhexanoate, 1,3 (4)-bis(tert-butylperoxyisopropyl) benzene, and mixtures thereof, preferably from the group consisting of dicumyl peroxide, n-butyl 4,4-di(tert-butylperoxy) valerate, OO-(t-butyl) O-(2-ethylhexyl) monoperoxycarbonate, tert-butyl peroxyisopropyl carbonate, tert-butyl peroxybenzoate, tert-butyl peroxy-3,5,5-trimethylhexanoate, 1,3 (4)-bis(tert-butylperoxyisopropyl) benzene, and mixtures thereof.
23. Rubber composition according to any one of the preceding embodiments, in which the content of peroxide is within a range extending from 0.1 to 10 phr, preferably from 0.5 to 5 phr, more preferably from 1 to 4 phr.
24. Rubber composition according to any one of the preceding embodiments, the composition not comprising being free of sulfur as vulcanization agent, or comprising less than 0.9 phr, preferably less than 0.5 phr, preferably less than 0.3 phr, preferably less than 0.2 phr and preferably less than 0.1 phr, thereof.
25. Rubber composition according to any one of the preceding embodiments, the composition not comprising being free of reinforcing resin or comprises less than 1 phr, preferably less than 0.5 phr, thereof.
26. Tyre comprising a rubber composition defined in any one of Embodiments 1 to 25, preferably present in at least one internal layer of the tyre.
27. Tyre according to Embodiment 26, in which the at least one internal layer of the tyre is selected from the group consisting of carcass plies, crown plies, bead-wire fillings, crown feet, decoupling layers, edge rubbers, filler rubbers, tread underlayer and combinations of these internal layers, preferably tread underlayer.

### IV-EXAMPLES

### IV-1 Measurements and Tests Used

### IV-1.1 Determination of the Microstructure of the Elastomers

The microstructure of the ethylene-butadiene copolymers is determined by ¹H NMR analysis, assisted by ¹³C NMR analysis when the resolution of the ¹H NMR spectra does not make it possible to assign and quantify all the species. The measurements are performed using a Bruker 500 MHz NMR spectrometer at frequencies of 500.43 MHz for proton observation and 125.83 MHz for carbon observation. For the insoluble elastomers which have the ability to swell in a solvent, a 4 mm z-grad HRMAS probe is used for proton and carbon observation in proton-decoupled mode. The spectra are acquired at rotational speeds of from 4000 Hz to 5000 Hz. For the measurements on soluble elastomers, a liquid NMR probe is used for proton and carbon observation in proton-decoupled mode. The preparation of the insoluble samples is performed in rotors filled with the analysed material and a deuterated solvent enabling swelling, generally deuterated chloroform (CDCl₃). The solvent used must always be deuterated and its chemical nature may be adapted by a person skilled in the art. The amounts of material used are adjusted so as to obtain spectra of sufficient sensitivity and resolution. The soluble samples are dissolved in a deuterated solvent (about 25 mg of elastomer in 1 ml), generally deuterated chloroform (CDCl₃). The solvent or solvent blend used must always be deuterated and its chemical nature may be adapted by a person skilled in the art. In both cases (soluble sample or swollen sample): A 30° single pulse sequence is used for proton NMR. The spectral window is set to observe all of the resonance lines belonging to the analysed molecules. The accumulation number is adjusted in order to obtain a signal to noise ratio that is sufficient for the quantification of each unit. The recycle delay between each pulse is adapted to obtain a quantitative measurement. A 30° single pulse sequence is used for carbon NMR, with proton decoupling only during the acquisition to avoid nuclear Overhauser effects (NOE) and to remain quantitative. The spectral window is set to observe all of the resonance lines belonging to the analysed molecules. The accumulation number is adjusted in order to obtain a signal to noise ratio that is sufficient for the quantification of each unit. The recycle delay between each pulse is adapted to obtain a quantitative measurement. The NMR measurements are performed at 25° C.

### IV-1.2 Determination of the Macrostructure of the Polymers by Size Exclusion Chromatography (SEC):

### a) Principle of the Measurement:

Size-exclusion chromatography or SEC makes it possible to separate macromolecules in solution according to their size by passage through columns packed with a porous gel.

The macromolecules are separated according to their hydrodynamic volume, the bulkiest being eluted first.

Combined with 3 detectors (3D), a refractometer, a viscometer and a 90° light-scattering detector, SEC makes it possible to comprehend the distribution of the absolute molar masses of a polymer. The various number-average (Mn) and weight-average (Mw) absolute molar masses and the dispersity (Ð=Mw/Mn) can also be calculated.

b) Preparation of the polymer:

Each sample is dissolved in tetrahydrofuran at a concentration of approximately 1 g/l. The solution is then filtered through a filter with a porosity of 0.45 μm before injection.

c) 3D SEC analysis:

In order to determine the number-average molar mass (Mn), and if appropriate the weight-average molar mass (Mw) and the polydispersity index (PI), of the polymers, the method below is used.

The number-average molar mass (Mn), the weight-average molar mass (Mw) and the polydispersity index of the polymer (hereinafter sample) are determined in an absolute manner by triple detection size exclusion chromatography (SEC). Triple detection size exclusion chromatography has the advantage of measuring average molar masses directly without calibration.

The value of the refractive index increment dn/dc of the solution of the sample is measured on-line using the area of the peak detected by the refractometer (RI) of the liquid chromatography equipment. To apply this method, it must be verified that 100% of the sample mass is injected and eluted through the column. The area of the RI peak depends on the concentration of the sample, on the constant of the RI detector and on the value of the dn/dc.

In order to determine the average molar masses, use is made of the 1 g/l solution previously prepared and filtered, which is injected into the chromatographic system. The apparatus used is a Waters Alliance chromatographic line. The elution solvent is tetrahydrofuran containing 250 ppm of BHT (2,6-di(tert-butyl)-4-hydroxytoluene), the flow rate is 1 ml.min⁻¹, the temperature of the system is 35° C. and the analytical time is 60 min. The columns used are a set of three Agilent columns of PL Gel Mixed B LS trade name. The volume of the solution of the sample injected is 100 μl. The detection system is composed of a Wyatt differential viscometer of Viscostar II trade name, of a Wyatt differential refractometer of Optilab T-Rex trade name of wavelength 658 nm and of a Wyatt multi-angle static light scattering detector of wavelength 658 nm and of Dawn Heleos 8+ trade name.

For the calculation of the number-average molar masses and the polydispersity index, the value of the refractive index increment dn/dc of the solution of the sample obtained above is integrated. The software for processing the chromatographic data is the Astra system from Wyatt.

### IV-1.3 Crystallinity Determination

The crystallinity measurement is carried out by measuring the enthalpy of fusion observed in the case of copolymers of ethylene and of 1,3-diene. This endothermic phenomenon is observed during the analysis of the thermogram of the DSC (Differential Scanning Calorimetry) measurement. The measurement is carried out by back-and-forth scanning from −150°° C. to 200°° C. under an inert (helium) atmosphere with a gradient of 20° C./min.

The signal corresponding to the endothermic (fusion) phenomenon is integrated and the degree of crystallinity is the ratio of the enthalpy measured to that of perfectly crystalline polyethylene (290 J/g).

% Crystallinity=(Enthalpy measured in J/g)/(theoretical enthalpy of a 100% crystalline polyethylene in J/g).

### IV-1.4 Dynamic Properties (After Curing): Tensile Test

These tensile tests make it possible to determine the elasticity stresses and the properties at break. Unless otherwise indicated, they are carried out in accordance with the standard NF ISO 37 of February 2018. Processing the tensile recordings also makes it possible to plot the curve of modulus as a function of the elongation. The modulus used here being the true secant modulus measured in first elongation, calculated by normalizing to the true cross section of the test specimen at any moment of the test. The nominal secant moduli (or apparent stresses, in MPa) at 10% elongation, denoted MSV10, are measured in first elongation.

The elongation at break (EB %) and breaking stress (BS) tests are based on the standard NF ISO 37 of December 2005 on an H2 dumbbell specimen and are measured at a tensile speed of 500 mm/min. The elongation at break is expressed as a percentage of elongation. The breaking stress is expressed in MPa.

All these tensile measurements are carried out under the standard conditions of temperature (23±2° C.) and hygrometry (50±5% relative humidity), according to French standard NF T 40-101 (December 1979).

The dynamic properties G*(10%) are measured on a viscosity analyser (Metravib VA4000) according to the standard ASTM D 5992-96. The response of a sample of crosslinked composition (cylindrical test specimen with a thickness of 4 mm and a cross section of 400 mm²), subjected to a simple alternating sinusoidal shear stress, at a frequency of 10 Hz, under defined temperature conditions, for example at 60° C., according to the standard ASTM D 1349-14, is recorded. A strain amplitude sweep is performed from 0.1% to 50% (outward cycle) and then from 50% to 1% (return cycle). The results made use of are the complex dynamic shear modulus G *. For the return cycle, the complex dynamic shear modulus G* at 10% strain, at 60° C., is shown.

For greater readability, the results are shown in base 100 (percentage), the value 100 being assigned to the control. A result greater than 100 indicating an improvement in the property concerned.

### IV-2 Synthesis of the Copolymer

In the synthesis of polymers, all the reactants are obtained commercially except the metallocenes. The butyloctylmagnesium BOMAG (20% in heptane, C=0.88 mol.1⁻¹) originates from Chemtura and is stored in a Schlenk tube under an inert atmosphere. The ethylene, of N35 grade, is obtained from the company Air Liquide and is used without prior purification.

The copolymer of ethylene and of 1,3-butadiene: elastomer E1 (in accordance with the invention) is synthesized according to the procedure described below.

To a reactor containing, at 80° C., methylcyclohexane, and also ethylene (Et) and butadiene (Bd) in the proportions indicated in Table 1, butyloctylmagnesium (BOMAG) is added to neutralize the impurities in the reactor, then the catalytic system is added (see Table 1). At this time, the reaction temperature is regulated at 80° C. and the polymerization reaction starts. The polymerization reaction takes place at a constant pressure of 8 bar. The reactor is fed throughout the polymerization with ethylene and butadiene (Bd) in the proportions defined in Table 1. The polymerization reaction is stopped by cooling, degassing of the reactor and addition of ethanol. An antioxidant is added to the polymer solution. The copolymer is recovered by drying in an oven under vacuum to constant mass. The catalytic system is a preformed catalytic system. It is prepared in methylcyclohexane from a metallocene, [Me₂SiFlu₂Nd(μ-BH₄)₂Li(THF)], a co-catalyst, butyloctylmagnesium (BOMAG), and a preformation monomer, 1,3-butadiene, in the contents indicated in Table 1. It is prepared according to a preparation method in accordance with paragraph II.1 of patent application WO 2017/093654 A1.

The microstructure of the copolymer E1 and the properties thereof are shown in Tables 2 and 3. For the microstructure, Table 2 indicates the molar contents of the ethylene (Eth) units, of the 1,3-butadiene units, and of the 1,2-cyclohexanediyl (ring) units.

TABLE 1

| Synthesis | E1 |
|---|---|
| Metallocene concentration (mmol/l) | 0.07 |
| Alkylating agent concentration (mmol/l) | 0.33 |
| Preformation monomer/Nd metal molar ratio | 90 |
| Feed composition (mol % Et/Bd) | 80/20 |

TABLE 2

| Elastomer | E1 |
|---|---|
| Ethylene (mol %) | 79 |
| 1,3-Butadiene (mol %) | 14 |
| 1,2-Cyclohexanediyl (mol %) | 7 |

TABLE 3

| Elastomer | E1 |
|---|---|
| Tg (° C.) | −41 |
| Mn (g/mol) | 130 700 |

### IV-3 Preparation of the Compositions

In the examples which follow, the rubber compositions were produced as described in point II-6 above. In particular, the “non-productive” phase was carried out in a 0.4 litre mixer for 2 minutes, for a mean blade speed of 80 revolutions per minute, until a maximum dropping temperature of 130°° C. was reached. The “productive” phase was carried out in an open mill at 23°° C. for 10 minutes.

The crosslinking of the composition was carried out in an MA plate-type mould at a temperature of 170°° C. for 15 minutes, under pressure.

### IV-4 Rubber Tests

The object of the examples presented below is to compare the mechanical properties of 3 compositions in accordance with the invention (C1, C2, C3) with two control compositions (T1 and T2). The compositions tested (in phr), as well as the results obtained, are presented in Tables 4 and 5.

TABLE 4

| | T1 | C1 | C2 | C3 |
|---|---|---|---|---|
| Components | | | | |
| NR⁽¹⁾ | — | — | — | — |
| EBR⁽²⁾ | 100 | 100 | 100 | 100 |
| HDPE⁽³⁾ | — | 13 (10) | 28 (20) | 55 (33) |
| (vol %) | | | | |
| Peroxide⁽⁴⁾ | 1 | 1 | 1 | 1 |
| Properties | | | | |
| MSV10 | 100 | 220 | 340 | 820 |
| EB (%) | 100 | 255 | 641 | 873 |
| BS | 100 | 161 | 467 | 1050 |

⁽¹⁾Natural rubber
⁽²⁾Elastomer E1 prepared above: Elastomer containing 79 mol % of ethylene units, 7 mol % of 1,2-cyclohexanediyl units, 8 mol % of 1,2 units, and 6 mol % of 1,4 units
⁽³⁾High density polyethylene “427985” from Sigma-Aldrich. Density = 0.952 g/cm³ measured in accordance with the standard ISO 1183-2019. Melt flow rate (MFR) = 12 g/10 min measured at 190° C. under the action of a piston weighted with a mass of 5 kg in accordance with the standard ISO 1133-1-2012
⁽⁴⁾“Dicup” peroxide from Sigma-Aldrich

TABLE 5

| | T2 | C3 |
|---|---|---|
| Components | | |
| NR⁽¹⁾ | 100 | — |
| EBR⁽²⁾ | — | 100 |
| HDPE⁽³⁾ | 52 (33) | 55 (33) |
| (vol %) | | |
| Peroxide⁽⁴⁾ | 1 | 1 |
| Properties | | |
| MSV10 | 100 | 121 |
| G* at 10% | 100 | 300 |
| EB (%) | 100 | 166 |
| BS | 100 | 121 |

⁽¹⁾ to ⁽⁴⁾see Table 4

The inventors have demonstrated that the specific combination of a copolymer containing ethylene units and diene units and of a polyethylene, in accordance with the invention, makes it possible to significantly improve all of the mechanical properties measured, in particular the limiting properties.

1.-15. (canceled)

16. A rubber composition based on an elastomer matrix containing more than 50 phr of at least one copolymer containing ethylene units and diene units, on from 0 to 50 phr of reinforcing filler, on at least 3 phr of a polyethylene and on a crosslinking system.

17. The rubber composition according to claim 16, wherein the at least one copolymer containing ethylene units and diene units is a copolymer of ethylene and of 1,3-diene.

18. The rubber composition according to claim 17, wherein the 1,3-diene is 1,3-butadiene.

19. The rubber composition according to claim 16, wherein the ethylene units in the at least one copolymer represent between 50 mol % and 95 mol % of the monomer units of the at least one copolymer.

20. The rubber composition according to claim 16, wherein the at least one copolymer is a random copolymer.

21. The rubber composition according to claim 16, wherein the polyethylene is a non-crosslinked polyethylene.

22. The rubber composition according to claim 16, wherein the polyethylene is selected from the group consisting of high density polyethylenes, low density polyethylenes, linear low density polyethylenes, medium density polyethylenes, ultra high molecular weight polyethylenes, very low density polyethylenes, and mixtures thereof.

23. The rubber composition according to claim 16, wherein the polyethylene has a density within a range extending from 940 to 970 kg/m³.

24. The rubber composition according to claim 16, wherein the polyethylene has a melt flow rate at 190°° C. under 5 kg within a range extending from 2 to 25 g/10 min.

25. The rubber composition according to claim 16, wherein the polyethylene is functionalized.

26. The rubber composition according to claim 25, wherein the functionalized polyethylene comprises at least one alkoxysilane functional group.

27. The rubber composition according to claim 16, wherein a content of polyethylene is within a range extending from 3 to 75 phr.

28. The rubber composition according to claim 16, wherein a content of reinforcing filler is within a range extending from 0 to 40 phr.

29. The rubber composition according to claim 16, wherein the reinforcing filler is selected from carbon blacks, silicas, and mixtures thereof.

30. A tire comprising the rubber composition according to claim 16.
